(19) United States
(12) Patent Application Publication
(10) Pub. No.: US 2005/0012825 A1
(43) Pub. Date: Jan. 20, 2005

(54) Low light level imaging devices

(76) Inventor: Paul K Kimber, Basildon (GB)

Correspondence Address: NIXON & VANDERHYE, PC, 1100 N GLEBE ROAD, 8TH FLOOR, ARLINGTON, VA, 22201-4714, US

(21) Appl. No.: 10/499,693

(22) PCT Filed: Dec. 13, 2002
(86) PCT No.: PCT/GB02/05662

(30) Foreign Application Priority Data
Dec. 21, 2001 (GB) 0130652.1

(51) Int. Cl. H04N 5/33

(52) U.S. Cl. 348/216.1; 348/164

(57) ABSTRACT

Described herein is a method and apparatus for enhancing regions in a low light level image (60) which includes a plurality of bright regions (62, 64, 66) and a person (100) in a region which has low light levels. The image (60) has a gain profile applied to it to compensate for the bright regions (62, 64, 66) and/or to enhance the person (100). The gain profile is derived from the image (60) itself and is chosen to reduce the bright regions (62, 64, 66) and/or enhance the person (100) and his surrounding area (102). If the person (100) only is of interest, the gain profile is such that, for each of lines “m” to “t”, a high gain is applied to pixels within the area (102) and a low gain is applied to pixels outside that area (102). Similarly, if only the bright regions (62, 64, 66) are of interest, a suitable gain profile is derived from the image (60) itself to allow detail in the bright regions (62, 64, 66) to be determined.

The present invention relates to improvements in or relating to low light level imaging devices.

It is often the case that a video signal or the like has a large dynamic amplitude range and when such a signal is to be displayed on an image display device, there is a loss of detail or information due to the image display device having a much lower dynamic amplitude range. This is particularly a problem for television or visible light emitting diode arrangements which are used for direct viewing of thermal or infrared information. For example, the dynamic amplitude range of video information obtained from an infrared camera or detector can be of the order 1000:1 whereas the maximum dynamic range provided by a suitable display monitor may only be 100:1. This means that detailed information may be lost in areas which are either predominantly black or predominantly white when unmodified video signals are displayed on the monitor, and only detail information in the intervening grey areas can be viewed without loss of contrast. Such a system is generally unsatisfactory as valuable detail information may be present in parts of a viewed scene which are predominantly very close to peak white levels or peak black levels.

GB-A-1 600 043 discloses a video signal processing arrangement which reduces the dynamic range of a video signal without producing a corresponding reduction in the amplitude of the fine detail. The arrangement increases the amplitude of high frequency video components corresponding to fine picture detail relative to low frequency video signal components corresponding to picture blocks, in particular, peak video signal levels are reduced whilst retaining or increasing the amplitude of high frequency signals corresponding to picture detail. This can be achieved in two ways. The first way is to limit an input video signal to form an inverted signal where all peak black and white regions have been removed and to sum the inverted signal with the original input signal to form an output signal which is the difference between the inverted signal and the original input signal. The output signal therefore has no grey picture information. The output signal is then filtered to remove d.c. components and is then combined with the inverted signal in a summing amplifier to produce a final signal which contains the original high frequency signals relating to the fine picture detail but within a reduced overall dynamic range which can readily be displayed. The second way is to apply the input video signal to both a high pass filter and a low pass filter, the former passing detail information while attenuating low frequencies and the latter passing picture block information while attenuating high frequencies. The signal from the low pass filter is limited and the limited signal is combined with the signal from the high pass filter in a summing circuit which can adjust the relative gain of the two frequency bands.

GB-A-2 059 705 discloses an electronic noise suppression system which eliminates distortion or fixed pattern noise in a charge-coupled device (CCD) delay line, the delay line acting as a temporary store of information in electrical form. The system inverts alternate signals of a succession of signals using a variable-sign amplifier prior to the delay line, and re-inverts them in a second variable-sign amplifier after removal from the delay line. This has the effect of reversing the distortion on sequential signals and significantly reduces distortion on any consecutive pair of signals. This system allows a visible output of a scene viewed by a CCD to be displayed.

However, the above techniques tend not to be suitable for low light level imaging devices as there is a need to discriminate detail in image highlights. This detail will tend to be lost in low light level imaging device, for example, low light level television (LLLTV) and CCD based sensors, and particularly in image intensifiers. In such devices, detail loss occurs when pixel charge wells are full and is a particular concern for devices using ‘avalanche’ gain stages between image readout and video output buffer.

It is therefore an object of the present invention to provide a low light level imaging device having an improved dynamic range.

In accordance with one aspect of the present invention, there is provided a method of enhancing regions in a low light level image, the method comprising the steps of:
reading out a stored video image;
analysing the video output of the image;
comparing the video outputs of selected pixels of the image to a reference value adjusting the gain profile to be applied to the image so as to reduce the gain to be applied to those pixels, the outputs of which exceed the reference value.

The method of the present invention has the advantage that the gain profile is relevant to the particular image and hence prevents saturation of pixels within the image and, as a consequence, loss of detail in areas of interest.

In one embodiment of the present invention, the gain profile is derived by applying a threshold to the image in accordance with selected image detail, deriving a compensational image from the thresholded image and applying the compensational image to the low light image to enhance the selected image detail.

In another embodiment, the gain profile is selected so as to provide high gain in the selected image detail and low gain elsewhere.

It will be appreciated that it is also possible to combine the two embodiments to select all regions of interest within an image frame. In accordance with another aspect of the present invention, there is provided apparatus for enhancing regions in a low light level image comprising:
means for storing the image;
means for reading out the image;
means for analysing the video output of the image;
means for comparing the video outputs of selected pixels of the image to a reference value; and
means for adjusting the gain profile to be applied to the image so as to reduce the gain to be applied to those pixels, the outputs of which exceed the reference value.

For a better understanding of the present invention, reference will now be made, by way of example, only to the accompanying drawings in which:

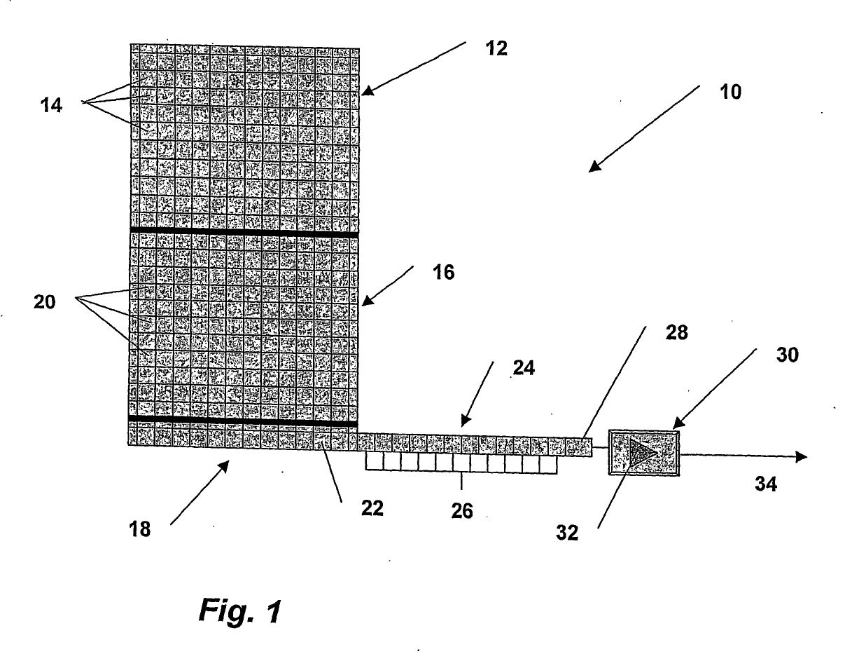

FIG. 1 illustrates schematically a low light level television (LLLTV) system;

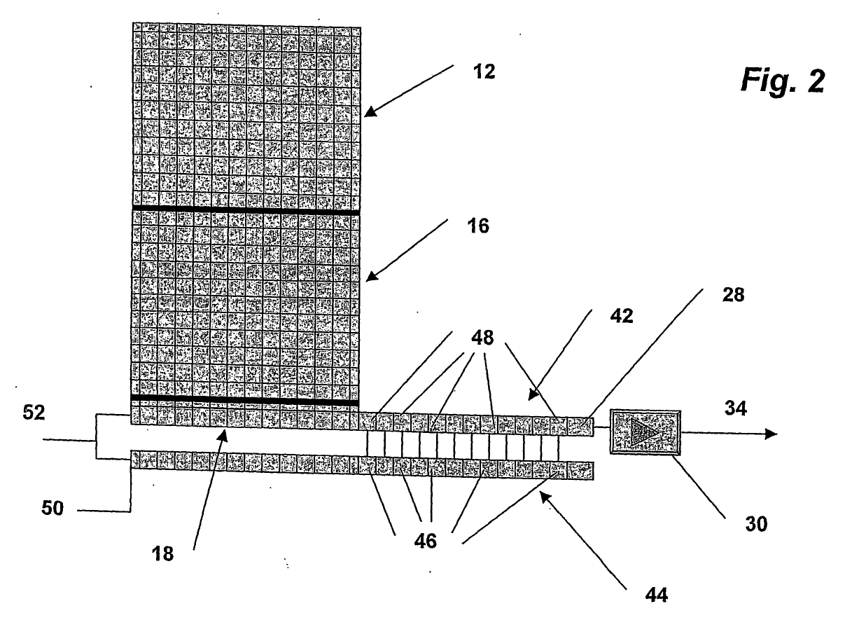

FIG. 2 illustrates schematically an LLLTV system embodying gain control in accordance with the present invention,

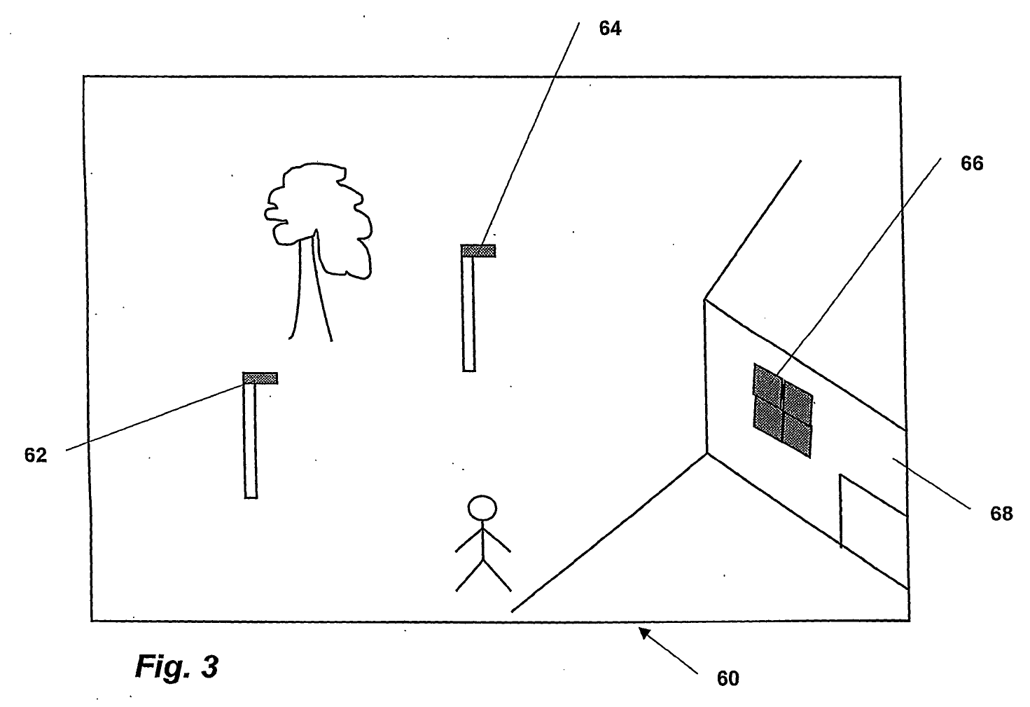

FIG. 3 illustrates a picture frame with items of possible interest;

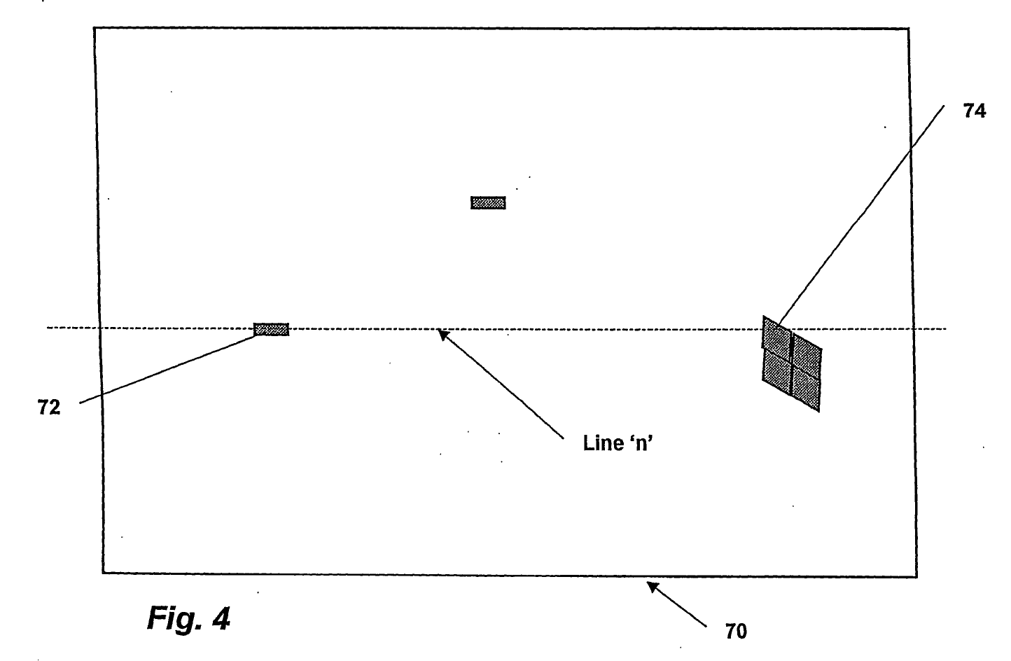

FIG. 4 is similar to FIG. 3 but illustrates only bright items of interest;

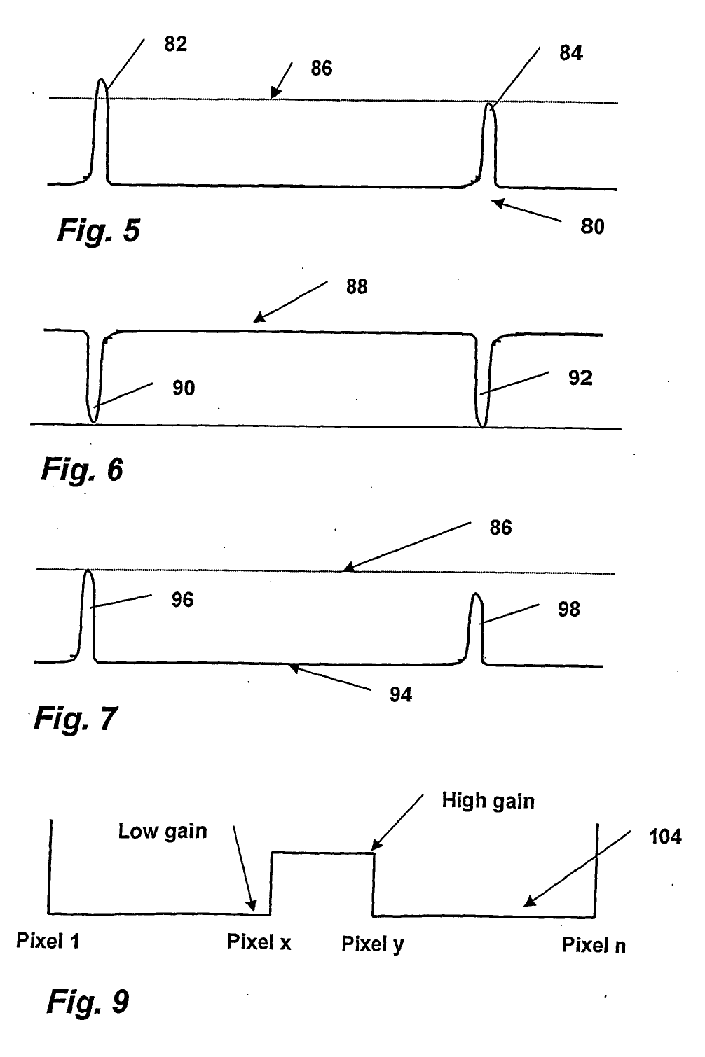

FIG. 5 shows the intensity of each pixel of line ‘n’ of FIG. 4 with respect to saturation;

FIG. 6 shows the correction to be applied to line ‘n’ of FIG. 5 to remove saturation;

FIG. 7 is similar to FIG. 5 but shows the correction applied for removal of saturation;

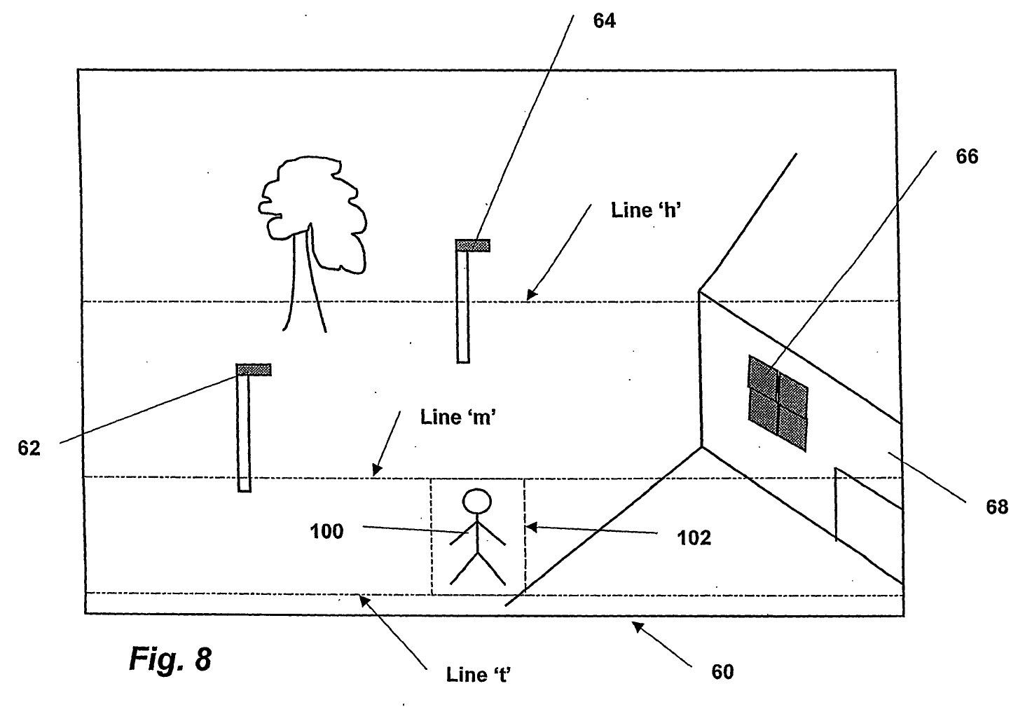

FIG. 8 is similar to FIG. 3 but selects a non-illuminated area of interest;

FIG. 9 illustrates the gain applied to line ‘m’ to line ‘t’ of FIG. 8; and

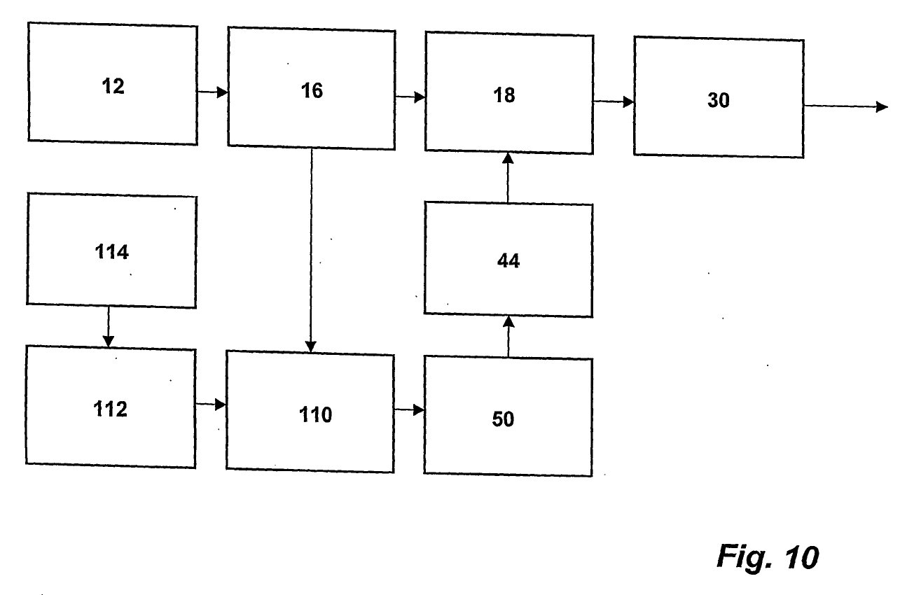

FIG. 10 illustrates a block diagram of apparatus which provides the pixel correction.

FIG. 1 illustrates a low light level television (LLLTV) system 10 which comprises an image array 12 comprising a plurality of detector or picture elements 14, an image store 16, and a readout mechanism 18. The array 12 receives light from a viewed scene (not shown) and each picture element 14, known as a pixel, collects light from a part of the viewed scene depending on its location in the array. Light from the viewed scene is normally focussed onto the array 12 by an optical system (not shown) as is well known.

Each pixel 14 has a dynamic range over which it collects light and is normally considered as a well for that dynamic range. It will readily be understood that light falling outside the dynamic range will not be detected.

The image of the viewed scene detected by the array 12 at any one time can be considered to comprise an image frame. This image frame is then transferred to an image store 16 which comprises an array of elements 20, the number of elements in the image store 16 being greater than or equal to the number of pixels 14 in the image array 12. Each element 20 in the image store 16 stores an electrical signal which corresponds to the amount of light received by the associated pixel 14 in the image array 12. The signals stored in each line of elements 20 in the image store 16 are clocked down into the readout mechanism 18 on a line by line basis.

As shown, the LLLTV system 10 further includes a gain mechanism 24, a charge detection mechanism 28 and a readout device 30. Each readout line 22 is then clocked into the gain mechanism 24 where a gain value is applied to each signal of the readout line 22. The value of the gain to be applied to the readout line 22 is input to the gain control mechanism via a gain input 26.

As will readily be understood, each signal can be considered to be a charge and is detected at the charge detection mechanism 28 where the value of each signal is determined and passed to the readout device 30 which may include an amplifier 32 and a buffer (not shown). The readout device 30 provides an output 34 which is passed to processing apparatus (not shown).

In the LLLTV system 10 described above, the same gain value is applied to each signal in each readout line 22. This means that if a signal in the readout line 22 has a relatively high value, it may be compressed after it has had the gain value applied to it due to limiting of the value of each signal at the charge detection mechanism 28. This leads to a compressed dynamic range for the LLLTV system 10.

In accordance with the present invention, an LLLTV system is provided in which the dynamic range is improved. This is achieved by applying a gain profile to the signals in the readout line 22 as will now be described with reference to FIG. 2. In FIG. 2, components of LLLTV system 40 which have previously been described with reference to FIG. 1 bear the same reference numerals.

The LLLTV system 40 comprises an image array 12, an image store 16, a readout mechanism 18, a charge detection mechanism 28 and a readout device 30 as before. However, the system 40 includes a different gain mechanism 42 for applying gain to the signals in the readout line 22. The gain control mechanism 42 includes a gain profile register 44 which has elements 46 connected to respective elements 48 in the readout line 22. This means that each signal in the readout line 22 can have an individual gain value applied to it. The individual gain values are determined from the image itself and are input to the gain profile register 44 as a gain profile input 50. A readout clock 52 is connected to the readout mechanism 18 and the gain profile input 50 so that the readout line 22 can be synchronised with the gain profile input 50 to ensure that the correct gain value of the gain profile input 50 is applied to the correct signal in the readout line 22.

The gain profile for applying to the image may potentially be derived in a number of ways. At one end of the complexity scale, the gain profile may comprise a common uniform gain applied to all pixels as described with reference to FIG. 1. At the other end of the complexity scale, the gain profile may comprise a complex and context dependent function which involves both information content in the image and/or user inputs.

The gain profile input 50 is determined from the image itself in accordance with the present invention by looking at the saturation or the amount of charge in each detector pixel well. If the well is saturated, the gain voltage applied to that pixel is reduced to bring the pixel below saturation. For example, it would be possible to minimise the effects of bright lights in the viewed scene, that is, ‘halation’ and other image artefacts. It will be appreciated that here the image highlights are compressed without affecting other areas of the image.

Alternatively, it would be possible to select a given area of an image and utilise a user input to allow that area to be ‘brighted up’ by applying additional gain on specific pixels and/or by reducing the gain elsewhere. This would help to identify specific areas of image in an image in a similar way to security camera image processing.

Furthermore, it would also be possible to reduce the gain applied in some parts of the image to effectively ‘deselect’ known areas which are not of interest.

In accordance with the present invention, it is desired to extend the apparent dynamic range of a sensor comprising a plurality of pixels so that when there are ‘bright sources’ in the field of view, gain control operates to compensate for such ‘bright sources’. Therefore, the gain profile input 50 initially loads the gain profile register 44 with a constant control voltage as described with reference to FIG. 1. When an image is captured, readout and then processed to analyse the video output, the maximum signal outputs are measured and compared to a reference value. The reference value is derived from the maximum video level that the sensor can generate, and is a function of the gain and maximum charge that each sensor pixel well can hold. In this way, it is possible to determine whether the charge in the wells associated with each picture point is above or below the level which causes maximum video output to be generated. It will be appreciated that once the video output reaches that maximum value, it saturates and the analogue image content or grey scale is lost.

The processing function determines the addresses of those pixels which cause the video output to saturate and thus provides a ‘mapping’ of those pixels where the gain voltage in the gain profile register 44 needs to be reduced. This has the objective of reducing the individual pixel gains such that the video from those pixels stays within the maximum available output.

There are many algorithms that can be applied to the video output to determine how much gain reduction needs to be applied to individual pixels. One technique could be to reference everything to the pixel with the highest video output (peak referencing). Here, the gain voltage is adjusted to ensure that the highest video output pixel just reaches saturation and is applied to all pixels which saturate under ‘uniform gain’ conditions. This has the advantage that at least some of the analogue information is maintained within individual pixels. This is shown in FIGS. 3 to 9.

FIG. 3 shows a picture frame 60 which has two street lights 62, 64 and a lighted window 66 in a house 68. The lighted window 66 is less bright than the street lights 62, 64. If a uniform gain is applied to each pixel in the picture frame 60, the pixels corresponding to the street lights 62, 64 and the window 66 will saturate.

However, if the video output from the picture frame 60 is compared to a reference voltage, a saturated pixel map 70 is obtained as shown in FIG. 4. Here, if a line ‘n’, for example, is taken across the saturated pixel map 70, it will contain pixel 72 from the street lamp 62, and pixel 74 from the lighted window 66.

When line ‘n’ is viewed as a pixel position intensity graph 80, FIG. 5, it is noted that intensity 82 corresponding to pixel 72 is above saturation and its output is clipped, and intensity 84 corresponding to pixel 74 has an output which is just saturated, the saturation line being illustrated by dotted line 86. The is graph 80 is then used to generate a control voltage waveform 88 for line ‘n’ as shown in FIG. 6. The waveform 88 includes reduced voltage values 90, 92 which respectively correspond to pixels 72, 74 of the saturated pixel map 70 and intensity values 82, 84 of graph 80. The reduced voltage values 90, 92 are determined to eliminate clipping on the highest intensity signal (in this case, the signal corresponding to the street light 62). The same reduced voltage value is applied to both the pixels 72, 74 corresponding to the street light 62 and the window 66. This results in an output signal 94 having a just saturated pixel value 96 for the street light 62 and a sub-saturated pixel value 98 for the window 66 as shown in FIG. 7. The output signal 94 preserves some analogue content in the image.

Whilst FIGS. 4 to 7 illustrate what happens for one line ‘n’ in a picture frame 60, it will be appreciated that the method described above is carried out for each line in the frame 60 and then iterated for each frame of a video image (not shown).

FIG. 8 is similar to FIG. 3 and identical items bear the same reference numerals. In this case, however, it is desired to highlight the ‘man’ 100 in the picture frame 60. In order to do this, a ‘high gain’ box 102 is selected around the man 100 in which the gain for lines and pixels is controlled.

For example, line ‘h’ will have uniform gain across all pixels as there is nothing of interest in that line. Similarly, for lines above and below line ‘h’, a constant gain is applied where there is no interest. However, at line ‘m’ which corresponds to the top of box 102 as shown, a non-uniform gain profile is required. A non-uniform gain is also required for all lines between line ‘m’ and line ‘t’ within the picture frame 60.

FIG. 9 illustrates a possible gain profile 104 which is suitable for each of lines ‘m’ to ‘t’ so that the man 100 is enhanced. In FIG. 9, a low gain profile exists from pixel 1 to pixel x, corresponding to one edge of the box 102, and from pixel y, corresponding to another edge of the box 102, to pixel n. A high gain profile is provided for all pixels between pixel x and pixel y.

In principle, the level of gain control provided within the box 102 can be up to the maximum gain that each pixel can have, and the level of gain in the ‘non-selected’ area, that is, outside the box 102, can go down to the basic sensitivity of each pixel, for example, no gain voltage applied. In a further implementation, it may be possible to ‘switch off’ all imaging from outside the desired box, for example, box 102. By varying the gain voltage inside and outside the box 102, for example, it is possible to alter the apparent ‘contrast’ of the image in the picture frame 60.

Although a rectangular box 102 is shown, it will be appreciated that any size or geometry may be chosen for the ‘box’ which can be inserted into a picture frame by suitable control waveforms.

As an alternative to what is described above with reference to FIGS. 3 to 8, it would be possible to adjust the gain of each pixel so that it just achieves saturation. This would allow the gain in other regions of the image to be increased thereby extending the dynamic range in low light level areas of the image.

FIG. 10 illustrates a block diagram of a system for implementing the gain control as described above with reference to FIGS. 2 to 9. Items described previously with respect to FIG. 2 are reference the same.

As shown in FIG. 10, an image is received by the image array 12 and passed to the image store 16 prior to being readout by the readout mechanism 18. As described above, gain profile input 50 applies a gain profile to gain profile register 44. The gain profile input 50 is derived from the image store 16. Each line of the image store 16 is fed out to a profiling unit 110 which applies a threshold to each line from the image store 16 to determine which pixels are saturated (if any) and to make any adjustments required to provide the gain profile input 50 for that line. The threshold applied by the profiling unit 110 is selected by a mode selector unit 112 in accordance with one of a plurality of operation modes stored in an operation modes store 114.

One example of an operation mode stored in store 114 is the selection of box 102 in FIG. 8. When this mode is selected, the pixels within the box 102 are enhanced and the others outside the box are attenuated. Another example is that described above with reference to FIGS. 2 to 7. Naturally, other suitable modes of operation are also possible.

1. A method of enhancing regions in a low light level image, the method comprising the steps of:
a) reading out a stored video image;
b) analysing the video output of the image;
c) comparing the video outputs of selected pixels of the image to a reference value
d) adjusting the gain profile to be applied to the image so as to reduce the gain to be applied to those pixels , the outputs of which exceed the reference value.

2. A method according to claim 1, wherein step (b) comprises determining the pixel of the image with the highest video output and step (d) further comprises determining the gain voltage required to cause the pixel with the highest video output to just reach saturation and applying said determined gain voltage to the pixels whose output exceed the reference value.

3. A method according to any one of the preceding claims, wherein step a) comprises reading out the stored image on a line-by-line basis, the gain profile being determined and applied on a line-by-line basis.

4. Apparatus for enhancing regions in a low light level image comprising:
means for storing the image;
means for reading out the image;
means for analysing the video output of the image;
means for comparing the video outputs of selected pixels of the image to a reference value;
means for adjusting the gain profile to be applied to the image so as to reduce the gain to be applied to those pixels, the outputs of which exceed the reference value.

5. Apparatus according to claim 4, wherein the means for analysing the video output of the image comprises means for determining the pixel of the image with the highest video output and the means for adjusting the gain profile to be applied to the image comprises means for determining the gain voltage required to cause the pixel with the highest video output to just reach saturation and means for applying said determined gain voltage to the pixels whose output exceed the reference value.
